(19) United States
(12) Patent Application Publication
(10) Pub. No.: US 2020/0250427 A1
(43) Pub. Date: Aug. 6, 2020

(54) SHADOW AND CLOUD MASKING FOR AGRICULTURE APPLICATIONS USING CONVOLUTIONAL NEURAL NETWORKS

(71) Applicant: Farmers Edge Inc., Winnipeg (CA)

(72) Inventors: Ali Mashhoori, Lethbridge (CA); Jacob Walker Bengtson, Houston, TX (US); David Eric Chalmers, Magrath (CA); Changchi Xian, Calgary (CA); Chad Richard Bryant, Calgary (CA)

(73) Assignee: Farmers Edge Inc., Winnipeg (CA)

(21) Appl. No.: 16/780,206

(22) Filed: Feb. 3, 2020

Related U.S. Application Data
(60) Provisional application No. 62/802,202, filed on Feb. 6, 2019.

(51) Int. Cl. G06K 9/00; G06K 9/62; G06K 9/40; G06N 3/04; G06N 3/08

(52) U.S. Cl. CPC G06K 9/00657; G06K 9/628; G06N 3/08; G06N 3/0454; G06K 9/40

(57) ABSTRACT

A method for shadow and cloud masking for remote sensing images of an agricultural field using a convolutional neural network, the method includes electronically receiving an observed image, the observed image comprising a plurality of pixels and each of the pixels associated with corresponding band information and determining by a cloud mask generation module executing on the at least one processor a classification for each of the plurality of pixels in the observed image using the band information by applying a classification model, the classification model comprising a convolutional neural network comprising a plurality of layers of nodes. The cloud mask generation module applies a plurality of transformations to transform data between layers in the convolutional neural network to generate a cloud map.

### RELATED APPLICATIONS

This application claims priority to U.S. Provisional Application No. 62/802,202, filed Feb. 6, 2019, entitled “SHADOW AND CLOUD MASKING FOR AGRICULTURE APPLICATIONS USING CONVOLUTIONAL NEURAL NETWORKS”, and hereby incorporated by reference in its entirety.

### TECHNICAL FIELD

This invention describes a method and system applicable to satellite imagery for agricultural applications, which utilizes a cloud and shadow detection algorithm.

### BACKGROUND

Satellite images are often affected by the presence of clouds and their shadows. As clouds are opaque at the wavelength of visible light, they often hide the ground surface from Earth observation satellites. The brightening and darkening effects of clouds and shadows influence data analysis causing inaccurate atmospheric corrections and impedance of land cover classification. Their detection, identification, and removal are, therefore, first steps in processing satellite images. Clouds and cloud shadows can be screened manually but automating the masking is important where there may be thousands of images to be processed.

Related art systems for detecting clouds and shadows in satellite images focus on imagery that have numerous bands and a wealth of information with which to work. For example, some related art systems use a morphological operation to identify potential shadow regions, which are darker in the near infrared spectral range. The related art addresses how, given a cloud mask, a sweep is done through a range of cloud heights, and also addresses how the places where projected shadows would fall are calculated geometrically. The area of greatest overlap between the projections and the potential shadow regions is taken as the cloud mask. The related art, however, is only successful when using a large number (e.g., 7, 8, 9, etc.) of spectral ranges (i.e., “bands”) to accomplish this particular cloud masking task. It remains a challenge to accomplish cloud masking for agricultural applications with fewer bands.

### SUMMARY

Sometimes sufficient satellite bands are unavailable for the successful operation of cloud identification applications which inform agricultural field management decisions, and thus related art techniques are inadequate. Systems and methods are disclosed herein for cloud masking where fewer bands of information are available than required for processing by related art systems (e.g., one, two, three, four, or five). In some embodiments, the systems and methods disclosed herein apply to a satellite image including a near infrared band (“NIR”) and a visible red-green-blue (“RGB”) band. Utilizing a reduced number of bands enables cloud masking to be performed on satellite imagery obtained from a greater number of satellites.

In some embodiments, the systems and methods disclosed herein perform cloud masking using a limited number of bands by using a convolutional neural network trained with labelled images.

According to one aspect, a method for shadow and cloud masking for remote sensing images of an agricultural field using a convolutional neural network, the method includes electronically receiving an observed image, the observed image comprising a plurality of pixels and each of the pixels associated with corresponding band information and determining by a cloud mask generation module executing on the at least one processor a classification for each of the plurality of pixels in the observed image using the band information by applying a classification model, the classification model comprising a convolutional neural network comprising a plurality of layers of nodes. The cloud mask generation module applies a plurality of transformations to transform data between layers in the convolutional neural network to generate a cloud map. The classification may be selected from a set including a cloud classification, a shadow classification, and a field classification. The classification of each of the pixels is performed using five or fewer bands of the observed image which may include a red visible spectral band, a green visible spectral, a blue visible spectral band, a near infrared band, and a red-edge band. The method may further include applying the cloud mask to the observed image and using a resulting image to generate a yield prediction for the agricultural field or other decision. The classification model may be an ensemble of a plurality of classification models and the classification may be an aggregate classification based on the ensemble of the plurality of classification models. The plurality of layers of nodes may include a reduction layer, at least one convolutional layer, a concatenation layer, at least one deconvolutional layer, and a labeling layer. The method may further include using the cloud generation module executing on the one or more processors to train the classification model. The method may further include using the cloud generation module executing on the one or more processors for evaluating one or more classification models.

According to another aspect, a system for shadow and cloud masking for remotely sensed images of an agricultural field is provided. The system may include a computing system having at least one processor for executing a cloud mask generation module, the cloud mask generation module configured to: receive an observed image, the observed image comprising a plurality of pixels and each of the pixels associated with corresponding band information and determine by a cloud mask generation module executing on the at least one processor a classification for each of the plurality of pixels in the observed image using the band information by applying a classification model, the classification model comprising a convolutional neural network comprising a plurality of layers of nodes. The cloud mask generation module may apply a plurality of transformations to transform data between layers in the convolutional neural network to generate a cloud map. The classification may be selected from a set including a cloud classification, a shadow classification, and a field classification. The classification of each of the pixels may be performed using five or fewer bands of the observed image. The band information may consist of information from five or fewer bands including a red visible band, a green visible band, and a blue visible band. The band information may consist of information from one or more visible bands, a near infrared band, and a red edge band. The classification model may be an ensemble of a plurality of classification models and wherein the classification may be an aggregate classification based on the ensemble of the plurality of classification models. The plurality of layers of nodes may include a reduction layer, at least one convolutional layer, a concatenation layer, at least one deconvolutional layer, and a labeling layer. The cloud generation module may be further configured to train the classification model. The cloud generation module may be further configured to evaluate one or more classification models. The computer system may be further configured to apply the cloud mask to the observed image and using a resulting image to generate a yield prediction for the agricultural field.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a system environment for generating a cloud map for an agricultural field, according to one example embodiment.

FIG. 2A illustrates an observed image, according to one example embodiment.

FIG. 2B illustrates a first layer of a cloud map, according to one example embodiment.

FIG. 2C illustrates a second layer of a cloud map, according to one example embodiment.

FIG. 3A illustrates an example of a data flow through a classification model, according to one example embodiment.

FIG. 3B illustrates an example of data flow through a classification ensemble, according to one example embodiment.

FIG. 4 illustrates a method for training a classification model according to one example embodiment.

FIG. 5 illustrates a method for generating a cloud map, according to one example embodiment.

FIG. 6 illustrates an example computing system, according to one example embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the disclosed principles. It is noted that wherever practicable similar or like reference numbers may be used in the figures and may indicate similar or like functionality. The figures depict embodiments of the disclosed system (or method) for purposes of illustration only.

### System Environment

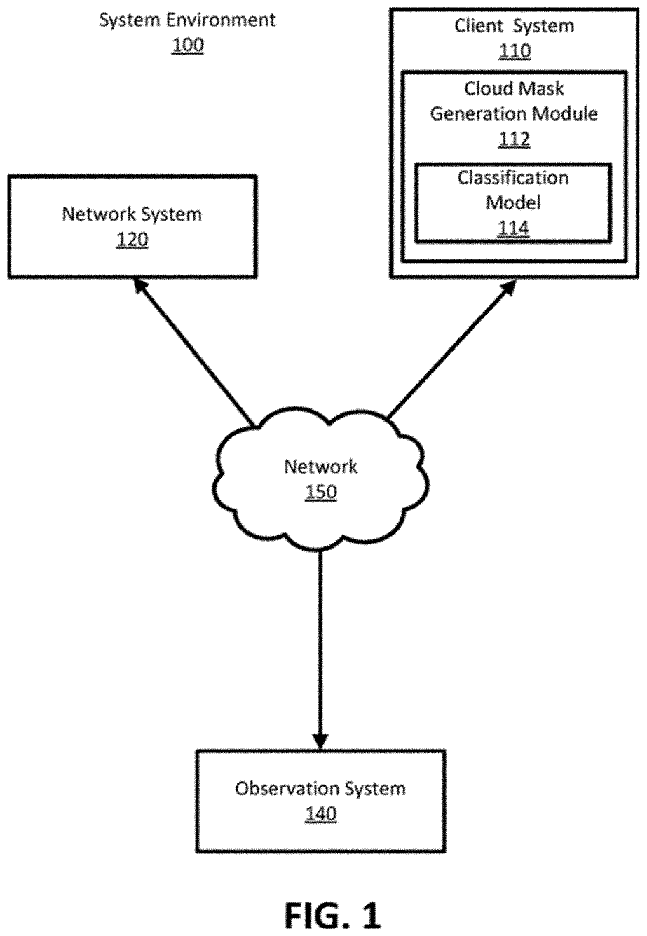

FIG. 1 illustrates a system environment for generating a cloud map for an agricultural field. Within the system environment 100, a client system 110 includes a cloud mask generation (“CMG”) module 112 that generates a cloud map. A cloud map is an image of an agricultural field in which a classification for each pixel in the image has been determined by the CMG module 112. The classifications may be, for example, “cloud,” “shadow,” and/or “field.” In other examples, a cloud map is some other data structure or visualization indicating classified clouds, shadows, and fields in an observed image.

The CMG module 112 employs a classification model 114 to generate a cloud map from an observed image of an agricultural field. The client system 110 may request observed images via the network 150 and the network system 120 may provide the observed images in response. The network 150 is typically a cell tower but can be a mesh network or power line. The network system 120 is typically the Internet but can be any network(s) including but not limited to a LAN, a MAN, a WAN, a mobile wired or wireless network, a private network, a virtual private network, or a combination thereof. A network system 120 accesses observed images from an observation system 140 via a network 150.

In various embodiments, the system environment 100 may include additional or fewer systems. Further, the capabilities attributed to one system within the environment may be distributed to one or more other systems within the system environment 100. For example, the CMG module 112 may be executed on the network system 120 rather than the client device 110.

The CMG module 112 inputs an observed image from the network system 120 and outputs a cloud map to a user of the client system 110. The CMG module 112 may also input an observed image from the observation system 140. Imagery data may consist of an image or photograph taken from a remote sensing platform (airplane, satellite, or drone). Imagery is a raster data set; each raster being comprised of pixels. Each pixel has a specific pixel value (or values) that represents ground characteristics. The observed images include a number of pixels. Each pixel includes information in a number of data channels (e.g., 3, 4, 5), each channel associated with a particular spectral band (“band information”). The CMG module 112 uses the band information to generate the cloud map.

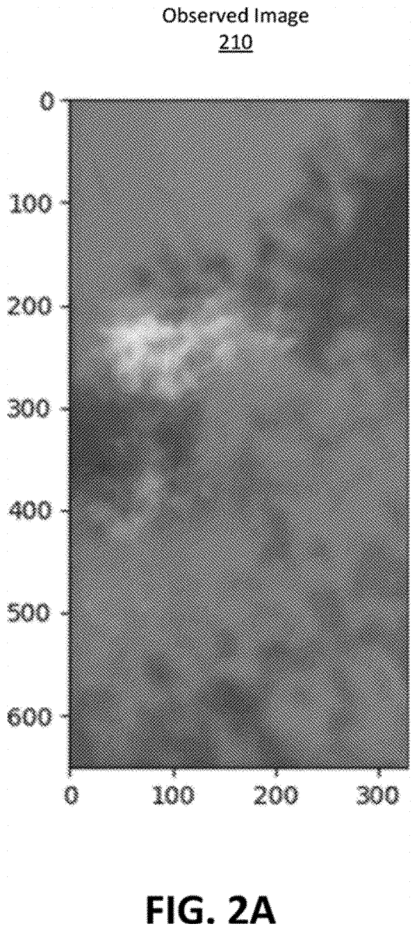

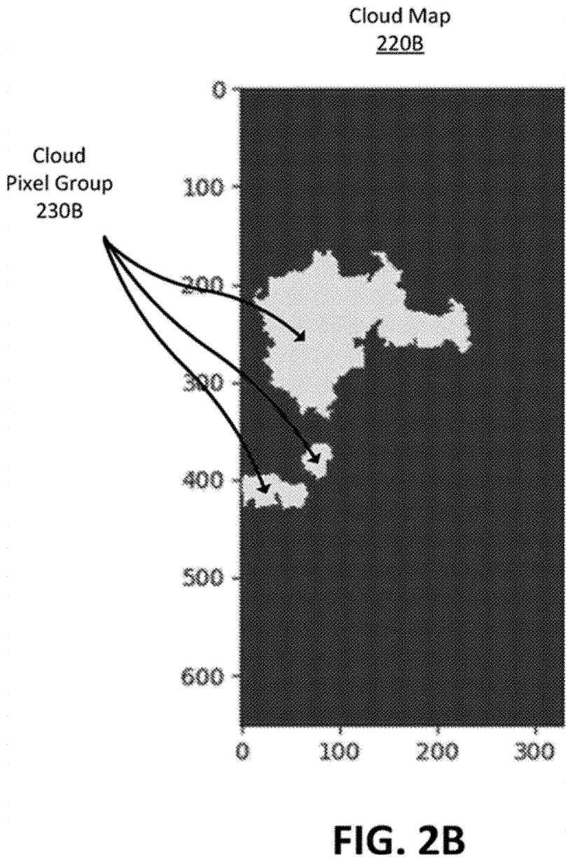

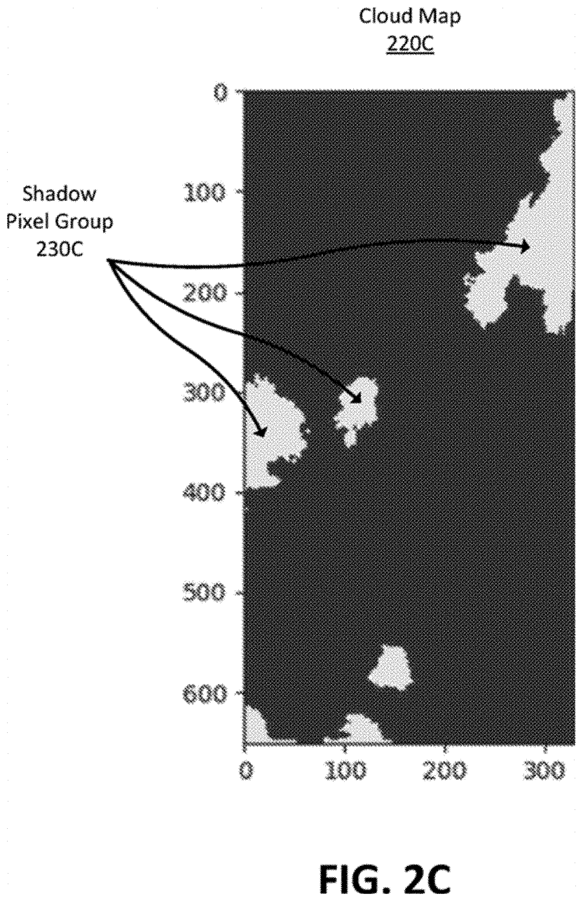

In one example, an observed image is an image taken of an agricultural field from a satellite or a satellite network. Space-based satellites use Global Positioning System (GPS) data, which may consist of coordinates and time signals to help track assets or entities. FIG. 2A illustrates an example of an observed image, according to one example embodiment. The illustrated example the observed image 210 is an RGB image of an agricultural field. More particularly, in this example, the observed image is a GeoTIFF image including geo-information associated with the image. The band information of the observed image 210 includes three data channels including a red spectral band, a green spectral band, and a blue spectral band.

In various embodiments, observed images may have different band information. For example, an observed image may have multi-spectral bands (e.g., six or more bands) obtained by a satellite. Some examples of satellite images having multi-spectral bands include images from LANDSAT™ and SENTINEL™ satellites. In other examples, a satellite image may only have four or five bands. Some examples of satellite images having five bands are images from PLANETSCOPE™ Dove and Planetscope RAPIDEYE™ satellites. In these examples, the band information includes five spectral bands: R, G, B, RED EDGE, and NIR bands. Some examples of satellite images having four bands include DOVE imaging from PLANETSCOPE. In these examples, the four bands include R, G, B, and NIR.

To generate the cloud map 220, the CMG module 112 determines a classification for each pixel in the observed image 210. FIG. 2B and FIG. 2C illustrate two layers of a cloud map, according to one example embodiment. FIG. 2B illustrates a layer of the cloud map (e.g., cloud map 220A) illustrating groups of pixels 230A classified as clouds, and FIG. 2C illustrates a layer of the cloud map (e.g., cloud map 220B) illustrating groups of pixels 230B classified as shadows. Notably, the cloud map is a GeoTIFF image having the same size and shape as the observed image 210 such that the classified pixels of the cloud map 210 correspond to similarly positioned pixels in the observed image 210.

There are several benefits of this system to growers and agronomists. For example, a cloud map can be applied to various downstream projects. Examples include yield forecasting, crop type classification, and crop health. In these applications, the goal is to eliminate non-informative pixels that are related to cloud and shadow, thus focusing on information from the agricultural portion of the image.

To illustrate, for example, field managers may wish to predict a yield for their agricultural field using an observed image. If the observed image includes pixels representing cloud shadow, and field, the model predicting the yield of the agricultural field may generate erroneous results. This may be caused by the clouds and shadows adversely affecting detection of healthy and unhealthy areas of plant matter in the field. As such, the cloud map may be used as a mask for the observed image. In other words, pixels that are identified as clouds or shadows may be removed from an observed image before using the observed image to generate a yield prediction for the agricultural field. Masking the cloud and shadow pixels from the observed image increases the accuracy of the yield prediction model.

### Convolutional Neural Network to Identify Clouds

In general, data collected are processed to derive values that can drive functions such as visualization, reports, decision making, and other analytics. Functions created may be shared and/or distributed to authorized users and subscribers. Data modelling and analytics may include one or more application programs configured to extract raw data that is stored in the data repository and process this data to achieve the desired function. It will be understood by those skilled in the art that the functions of the application programs, as described herein, may be implemented via plurality of separate programs or program modules configured to communicate and cooperate with one another to achieve the desired functional results.

In an embodiment, data modelling and analytics may be configured or programmed to preprocess data that is received by the data repository from multiple data sources. The data received may be preprocessed with techniques for removing noise and distorting effects, removing unnecessary data that skew other data, filtering, data smoothing data selection, data calibration, and accounting for errors. All these techniques should be applied to improve the overall data set.

In an embodiment, the data modelling and analytics generates one or more preconfigured agronomic models using data provided by one or more of the data sources and that are ingested and stored in the data repository. The data modelling and analytics may comprise an algorithm or a set of instructions for programming different elements of a precision agriculture system. Agronomic models may comprise calculated agronomic factors derived from the data sources that can be used to estimate specific agricultural parameters. Furthermore, the agronomic models may comprise recommendations based on these agricultural parameters. Additionally, data modelling and analytics may comprise agronomic models specifically created for external data sharing that are of interest to third parties.

In an embodiment, the data modelling and analytics may generate prediction models. The prediction models may comprise one or more mathematical functions and a set of learned weights, coefficients, critical values, or any other similar numerical or categorical parameters that together convert the data into an estimate. These may also be referred to as “calibration equations” for convenience. Depending on the embodiment, each such calibration equations may refer to the equation for determining the contribution of one type of data or some other arrangement of equations may be used.

Client system 110 includes a CMG module 112 that employs a classification model 114 to identify features (e.g., clouds, fields, etc.) in an observed image 200 to generate a cloud map 220. The CMG module 112 determines a classification for pixel using the band information for each pixel.

In an example embodiment, the classification model 114 is a convolutional neural network (CNN) but could be another type of supervised classification model. Some examples of supervised classification models may include, but are not limited to, multilayer perceptrons, deep neural networks, or ensemble methods. Given any of these models, the CMG module 112 learns, without being explicitly programmed to do so, how to determine a classification for a pixel using the band information for that pixel.

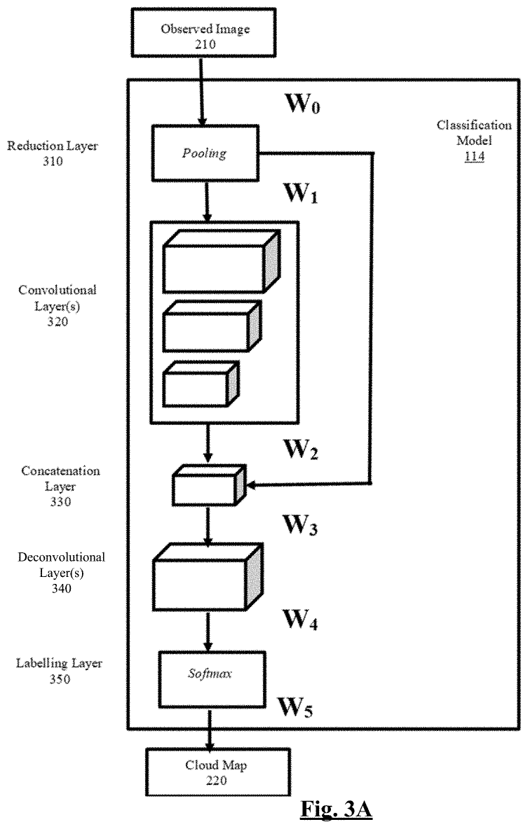

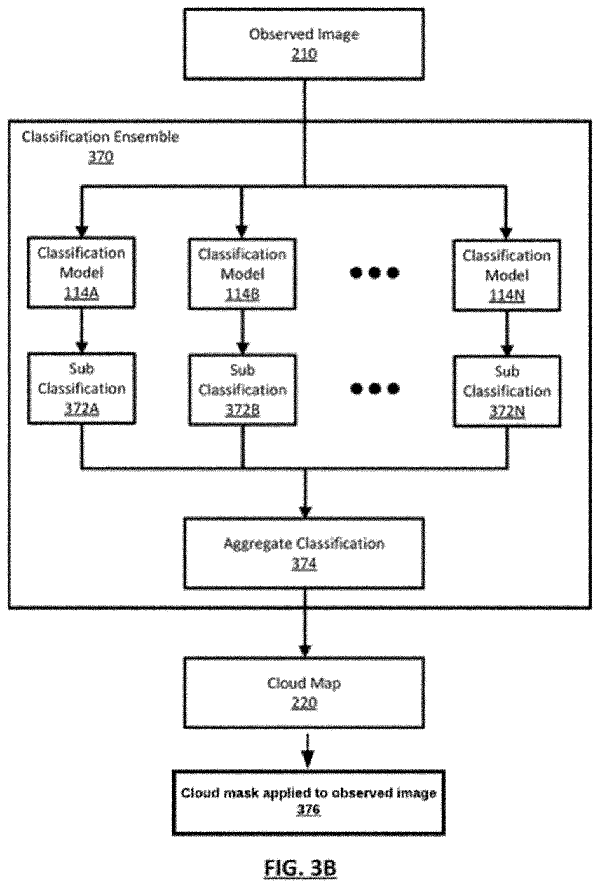

FIG. 3A is a representation of a convolutional neural network employed by the CMG module 112 as a classification model 114, according to one example embodiment. The CMG module 112 employs the CNN to generate a cloud map 220 from an observed image 210 based on previously observed images with identified and labelled features. The previously identified features may have been identified by another classification model or a human identifier.

In the illustrated embodiment, the classification model 114 is a CNN with layers of nodes. The values at nodes of a current layer are a transformation of values at nodes of a previous layer. Thus, for example, CMG module 112 performs a transformation between layers in the classification model 114 using previously determined weights and parameters connecting the current layer and the previous layer. For example, as shown in FIG. 3, the example classification model 114 includes five layers of nodes: layers 310, 320, 330, 340, and 350. CMG module 112 inputs the data object (e.g., an observed image 210) into classification model 114 and moves the data through the layers via transformations. For example, as illustrated, the CMG module 112 transforms from the input data object to layer 310 using transformation W₀, transforms layer 310 to layer 320 using transformation W₁, transforms from layer 320 to layer 330 using transformation W₂, transforms layer 330 to layer 340 using transformation W₃, and transforms layer 340 to layer 350 using transformation W₄. The CMG module 112 transforms layer 350 to an output data object (e.g., a cloud map) using transformation W₅. In some examples, CMG module 112 performs transformations using transformations between previous layers in the model. In other words, the weights and parameters for a previous transformation can influence a subsequent transformation. For example, the CMG module 112 transforms layer 330 to layer 340 using a transformation W₃ based on parameters CMG module 112 employed to transform the input data object to layer 310 using transformation Wo and/or information CMG module 112 generated by performing a function on layer 310.

In the illustrated embodiment, the input data object is an observed image 210 and the output data object is a cloud map 220. In other words, CMG module 112 encodes the observed image 210 onto the reduction layer 310, and CMG module 112 decodes a cloud map 220 from the labelling layer 350. During this process, the CMG module 112, using classification model 114, identifies latent information in the observed image 210 representing clouds, shadows, and fields (“features”) in the concatenation layer 330. CMG module 112, using classification model 114, reduces of the dimensionality of the reduction layer 310 to that of the concatenation layer 330 to identify the features. The CMG module 112, using classification model 114, subsequently, increases the dimensionality of the concatenation layer 330 to that of the labelling layer to generate a cloud map 220 with the identified features labelled.

As described above, CMG module 112 encodes an observed image 210 to a reduction layer 310. In the reduction layer 310, CMG module 112 reduces the pixel dimensionality of the observed image 210. In an example, in the reduction layer 310, the CMG module 112 uses a pooling function to reduce the dimensionality of the input image. Other functions may be used reduce the dimensionality of the observed image 210. In some configurations, CMG module 112 directly encodes an observed image to the reduction layer 310 because the dimensionality of the reduction layer 310 is the same as the pixel dimensionality of the observed image 210. In other examples, CMG module 112 adjusts (e.g., crops) the observed image 210 such that the dimensionality of the observed image 210 is the same as the dimensionality of the reduction layer 310.

An observed image 210 encoded in the reduction layer 310 can be related to feature identification information in the concatenation layer 330. CMG module 112 retrieves relevance information between features by applying a set of transformations between the corresponding layers. Continuing with the example from FIG. 3, the reduction layer 310 of the classification model 114 represents an encoded observed image 210, and concatenation layer 330 of the classification model 114 represents feature identification information. CMG module 112 identifies features in a given observed image 210 by applying the transformations W₁ and W₂ to the pixel values of the observed image 210 in the space of reduction layer 310 and the convolutional layers 320, respectively. The weights and parameters for the transformations may indicate relationships between information contained in the observed image 210 and the identification of a feature. For example, the weights and parameters can be a quantization of shapes, colors, etc. included in information representing clouds, shadows, and fields included in an observed image 210. CMG module 112 may learn the weights and parameters from historical user interaction data including cloud, shadow, and field identification submitted by users.

In one example, CMG module 112 collects the weights and parameters using data collected from previously observed images 210 and a labelling process. The labelling process can include having a human label region (e.g., polygons, areas, etc.) of pixels in an observed image as a cloud, shadow, or field, or weaker data such as the percentage of cloud cover, for example. Human labelling of observed images generates data for training a classification model to determine a classification for pixels in an observed image.

CMG module 112 identifies features in the observed image 210 in the concatenation layer 330. The concatenation layer 330 is a data structure representing identified features (e.g., clouds, shadows, and fields) based on the latent information about the features represented in the observed image 210.

CMG module generates a cloud map 220 using identified features in an observed image 210. To generate a cloud map, the CMG module 112, using classification model 114, applies the transformations W₃ and W₄ to the value of the features identified in concatenation layer 330 and deconvolutional layer 340, respectively. The weights and parameters for the transformations may indicate relationships between an identified feature and a cloud map 220. CMG module 112 applies the transformations which results in a set of nodes in the labelling layer 350.

CMG module 112 generates a cloud map 220 by labelling pixels in the data space of the labelling layer 350 with their identified feature. For example, CMG module 112 may label a pixel as cloud, shadow, or field. The labelling layer 350 has the same pixel dimensionality as the observed image 210. Therefore, the generated cloud map 220 can be seen as an observed image 210 with its various pixels labelled according to identified features.

Additionally, the classification model 114 can include layers known as intermediate layers. Intermediate layers are those that do not correspond to an observed image 210, feature identification, or a cloud map 220. For example, as shown in FIG. 3, the convolutional layers 320 are intermediate layers between the reduction layer 310 and the concatenation layer 330. Deconvolution layer 340 is an intermediate layer between the concatenation layer 330 and the labeling layer 350. CMG module 112 employs intermediate layers to identify latent representations of different aspects of a feature that are not observed in the data but may govern the relationships between the elements of an image when identifying that feature. For example, a node in the intermediate layer may have strong connections (e.g., large weight values) to input values and identification values that share the commonality of “puffy cloud.” As another example, another node in the intermediate layer may have strong connections to input values and identification values that share the commonality of “dark shadow.” Specifically, in the example model of FIG. 3, nodes of the intermediate layers 320 and 340 can link inherent information in the observed image 210 that share common characteristics to help determine if that information represents a cloud, shadow, or field in the observed image 210.

Additionally, CMG module 112, using the classification model 114, may act on the data in a layer's data space using a function or combination of functions. Some example functions include residual blocks, convolutional layers, pooling operations, skip connections, concatenations, etc. In a more specific example, the CMG module 112 employs a pooling function, which could be maximum, average, or minimum, in the reduction layer 310 to reduce the observed image dimensionality, convolutional, and transpose deconvolutional layers to extract informative features, and a softmax function in the labelling layer 350 to label pixels.

Finally, while illustrated with two intermediate layers (e.g., layers 320 and 340), the classification model 114 may include other numbers of intermediate layers. The CMG module 112, using classification model 114, employs intermediate layers to reduce the reduction layer 310 to the concatenation layer 330 and increase the concatenation layer 330 to the labelling layer 350. The CMG module 112 also employs the intermediate layers to identify latent information in the data of an observed image 210 that correspond to a feature identified in the concatenation layer 330.

### Ensembled Convolutional Neural Network

In an embodiment, CMG module 112 employs an ensemble of classification models (“classification ensemble”) to generate a cloud map 220. FIG. 3B illustrates the flow of data through a classification ensemble, according to one example embodiment. In this example, the classification ensemble 370 includes N classification models 112 (e.g., classification model 114A, classification model 114B, and classification model 114N), but could include additional or fewer classification models. Here, each classification model 114 is a convolutional neural network but could another classification models. The classification models 112 are trained to determine a sub-classification 372 for each pixel of an observed image 210. The sub-classifications 372 are, for example, cloud, shadow, or field.

Each classification model 114 in the classification ensemble 370 is trained using different training sets. For example, one classification model (e.g., classification model 114A) is trained using a first set of labelled training images, a second classification model (e.g., classification model 114B) is trained using a second set of labelled training images, etc. Because each classification model 114 is trained differently, the classification models 112 may determine different sub-classifications 372 for each pixel of an observed image 210. For example, CMG module 112 inputs a pixel into an ensemble including two classification models. The CMG module determines a sub-classification (e.g., sub-classification 372A) for a pixel is “cloud” when employing a first classification model (e.g., classification model 114A), determines a sub-classification (e.g., sub-classification 372B) for the pixel is “shadow” when employing a second classification model (e.g., classification model 114B).

To generate the cloud map 220, CMG module 112, via the classification ensemble 370, inputs the observed image 210 into each of the classification models 112. For each pixel of the observed image, the CMG module 112 employs each classification model 114 to determine a sub-classification 372 for the pixel. The CMG module 112 determines an aggregate classification 374 for each pixel based on the sub-classifications 372 for that pixel. In one example, the CMG module 112 determines the aggregate classification 374 for each pixel is the determined sub-classification 372 selected by the plurality of classification models 112. For example, the CMG module 112 determines sub-classifications 372 for a pixel as “field,” “cloud,” and “cloud.” The CMG module 112 determines the aggregate classification 374 for the pixel is cloud based on the determined sub-classifications 372. Other functions for determining the aggregate classification 374 are also possible.

The CMG module 112, using the classification ensemble 370, generates a cloud map 220 whose pixels are all labelled with the aggregate classification 374 determined by the classification ensemble 370 for that pixel. Using a classification ensemble 370 as opposed to a single classification model 114 increases the accuracy of cloud maps. For example, the accuracy of an ensemble of three classifiers may be 5 to 8% higher than each classifier alone.

### Training a Classification Model

The CMG module 112 trains a classification model 114 (e.g., a CNN) using a number of images having previously determined classifications for each pixel (“indicators”). In one example, an indicator is an observed image labelled by a human. To illustrate, the pixels of an observed image are shown to a human and the human identifies the pixels as cloud, shadow, or field. The band information for the pixels are associated with the classification and can be used to train a classification model. In another example, an indicator is an observed image having a classification determined by a previously trained model (“previous model”). To illustrate, the band information for pixels are input into a model trained to determine a classification for pixels. In this example, the previous model outputs a classification for the pixels and the band information for those superpixel are associated with the classification. The band information for the pixels are associated with the classification and can be used to train another classification model.

CMG module 112 trains the classification model 114 using indicators (e.g., previously labelled observed images). Each pixel in an indicator has a single classification and is associated with the band information for that pixel. The classification model 114 inputs a number of indicators and determines that latent information included in the band information are associated with specific classifications.

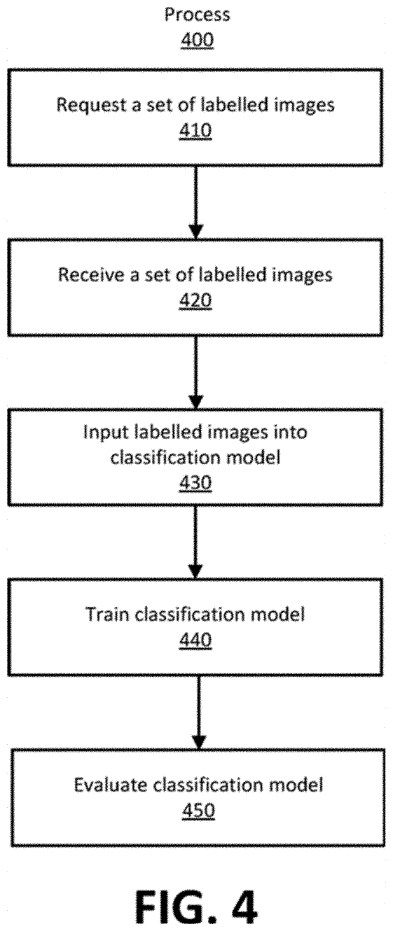

FIG. 4 illustrates a process for training a classification model, according to one example embodiment. In an example embodiment, the client system 110 executes the process 440. The CMG module 112 employs the classification model (e.g., classification model 114) to determine a classification for pixels of an observed image (e.g., observed image 210) as “cloud,” “shadow,” or “field.”

A CMG module requests 410 a set of labelled images from network system 120 to train a classification model. The network system accesses a set of labelled images from observation system 140 via a network. An actor generates 420 a labelled image by determining a classification for each pixel of the observed image. The actor may be a human or a previously trained classification model. The network system transmits the labelled images to the client system.

The CMG module 112 receives, at step 420, the labelled images and inputs, at step 430, the labelled images into a convolutional neural network (e.g., classification model 114) to train, at step 440, the CNN to identify clouds, shadows, and fields. The CNN is trained to determine clouds, shadows, and fields based on the latent information included in the band information for each pixel of a labelled image. In other words, the CNN determines weights and parameters for functions in a layer and transformations between layers that generate the appropriate pixel classification when given an input image.

The CMG module 112 evaluates, at step 450, the capabilities of the trained classification model using an evaluation function. As an example, CMG module 112 employs an evaluation function that compares an observed image that has been accurately classified by a human (“training image”) to an observed image classified by CMG module (“test image”). The evaluation function quantifies the differences between the training image and the test image using a quantification metric (e.g., accuracy, precision, etc.). If the quantification metric is above a threshold, the CMG module 112 determines that the classification model is appropriately trained. If the quantification metric is below a threshold, CMG module 112 further trains the classification model.

The CMG module 112 can utilize this process to train multiple classification models used in a classification ensemble (e.g., classification ensemble 370). In this case, the CMG module can input different labelled images of the received set into each classification model of the classification ensemble to train the classification models.

### Generating a Cloud Map

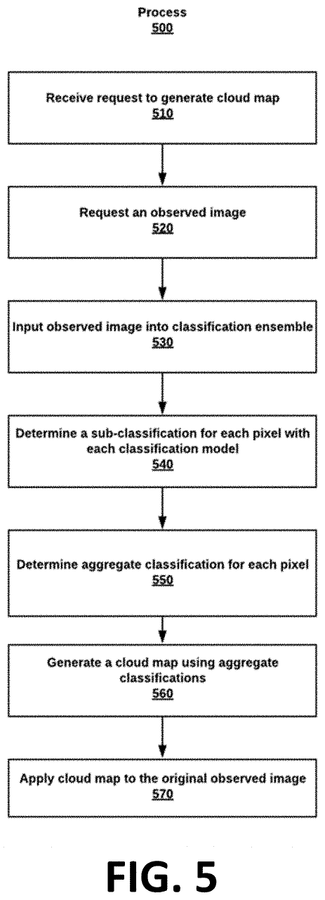

FIG. 5 illustrates a process for generating a cloud map, according to one example embodiment. In an example embodiment, the client system 110 executes the process 500 to generate a cloud map (e.g. cloud map 220).

The client system 110 receives, at step 510, a request to generate the cloud map 220 from a user of the client system. The client system 110 requests, at step 520, an observed image (e.g., observed image 210) from network system 120 via the network 150. The client system 110 receives the observed image 210 from network system 120 in response. The observed image 210 may be a satellite image obtained by observation system 140. In some embodiments, client system 110 may request the observed image 210 from observation system 140 and receive the observed image from observation system 140 in response.

The CMG module 112 inputs, at step 530, the observed image 210 into a classification ensemble (e.g., classification ensemble 370) to determine the cloud map 220. In an example, the classification ensemble 370 includes three classification models (e.g., classification model 114) trained to determine a classification for pixels in the observed image 210. Each of the classification models 114 is a convolutional neural network trained using a different set of labelled images.

The CMG module 112 determines, at step 540, for each classification model 114 in the classification ensemble 370, a sub-classification for every pixel in the observed image 210. In an example, the classification models identifies latent information in the observed image to determine a sub-classification for each pixel. The sub-classification may be “cloud,” “shadow,” or “field.”

The CMG module 112 determines, at step 550, an aggregate classification for each pixel of the observed image based on the sub-classifications for each pixel. For example, the CMG module may determine that the aggregate classification for a pixel is the sub-classifications determined by the plurality of classification models. Using the aggregate classification, at step 550, of each pixel, the generation of a cloud map using the aggregate classifications, at step 560, is made. The cloud map can be applied to the observed image, at step 570, to create an output image to be used for any number of applications such as yield predictions or determining crop health with an image more suited gaining a higher accuracy in those applications. For example, the CMG module 112 generates the cloud map 220 using the aggregate classifications for each pixel of the observed image 210. The cloud map 220 is, therefore, the observed image 210 with each pixel of the observed image labelled with determined classification.

Cloud pixels skew results by adding in high pixel values, thus affecting imagery techniques that utilize all pixels. Shadow pixels depress the intensity and can affect how data is interpreted but they do not have the large effect that cloud pixels have on the data average.

Quantitatively, removing both cloud and shadow pixels allows applications that use imagery techniques (for example crop health, yield prediction, and harvest information) to generate more accurate results. Pixels that affect the calculations of the product are removed and, therefore, do not dramatically alter the results. Growers will acquire improved information for their applications, which aids in achieving better agronomic decisions.

Qualitatively, the cloud removal eliminates pixels with extra high values that draw attention away from regions of valuable field information. The high pixel intensities create a poor data scale, hiding important information and potentially overwhelming small details that can be missed by a grower viewing a display. Removing these high-value pixels can ultimately improve the decision-making process. If higher-quality data is fed into applications addressing crop health or pests, for example, better agronomic decisions can then be made.

### Example Computer System

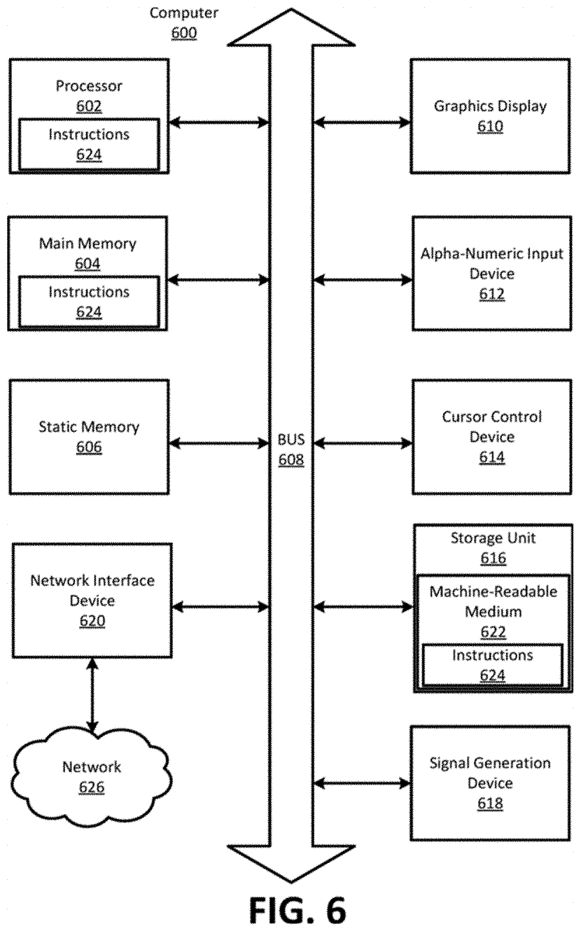

FIG. 6 is a block diagram illustrating components of an example machine for reading and executing instructions from a machine-readable medium. Specifically, FIG. 6 shows a diagrammatic representation of network system 120 and client device 110 in the example form of a computer system 600. The computer system 600 can be used to execute instructions 624 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client system environment 100, or as a peer machine in a peer-to-peer (or distributed) system environment 100.

The machine may be a server computer, a client computer, a personal computer (PC), a tablet PC, a set-top box (STB), a smartphone, an internet of things (IoT) appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes one or more processing units (generally processor 602). The processor 602 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 600 also includes a main memory 604. The computer system may include a storage unit 616. The processor 602, memory 604, and the storage unit 616 communicate via a bus 608.

In addition, the computer system 600 can include a static memory 606, a graphics display 610 (e.g., to drive a plasma display panel (PDP), a liquid crystal display (LCD), or a projector). The computer system 600 may also include alphanumeric input device 612 (e.g., a keyboard), a cursor control device 614 (e.g., a mouse, a trackball, a joystick, a motion sensor, or other pointing instrument), a signal generation device 618 (e.g., a speaker), and a network interface device 620, which also are configured to communicate via the bus 608.

The storage unit 616 includes a machine-readable medium 622 on which is stored instructions 624 (e.g., software) embodying any one or more of the methodologies or functions described herein. For example, the instructions 624 may include the functionalities of modules of the client device 110 or network system 120 described in FIG. 1. The instructions 624 may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 may be transmitted or received over a network 626 (e.g., network 120) via the network interface device 620.

While machine-readable medium 622 is shown in an example embodiment to be a single medium, the term “machine-readable medium” should be taken to include a single medium or multiple media (e.g., a centralized or distributed database, or associated caches and servers) able to store the instructions 624. The term “machine-readable medium” shall also be taken to include any medium that is capable of storing instructions 624 for execution by the machine and that cause the machine to perform any one or more of the methodologies disclosed herein. The term “machine-readable medium” includes, but not be limited to, data repositories in the form of solid-state memories, optical media, and magnetic media.

Although various examples and embodiments have been shown and discussed throughout, the present invention contemplates numerous variations, options, and alternatives.

What is claimed is:

1. A method for shadow and cloud masking for remote sensing images of an agricultural field using a convolutional neural network, the method comprising:
electronically receiving an observed image, the observed image comprising a plurality of pixels and each of the pixels associated with corresponding band information;
determining by a cloud mask generation module executing on the at least one processor a classification for each of the plurality of pixels in the observed image using the band information by applying a classification model, the classification model comprising a convolutional neural network comprising a plurality of layers of nodes;
wherein the cloud mask generation module applies a plurality of transformations to transform data between layers in the convolutional neural network to generate a cloud map.

2. The method of claim 1 wherein the classification is selected from a set comprising a cloud classification, a shadow classification, and a field classification.

3. The method of claim 1 wherein the classification of each of the pixels is performed using five or fewer bands of the observed image.

4. The method of claim 3 wherein the five or fewer bands includes a red visible spectral band, a green visible spectral band, and a blue visible spectral band.

5. The method of claim 4 wherein the five or fewer bands further includes a near infrared band.

6. The method of claim 5 wherein the five or fewer bands further includes a red-edge band.

7. The method of claim 1 further comprising applying the cloud mask to the observed image.

8. The method of claim 1 further comprising applying the cloud mask to the observed image and using a resulting image to generate a yield prediction for the agricultural field.

9. The method of claim 1 wherein the classification model is an ensemble of a plurality of classification models and wherein the classification is an aggregate classification based on the ensemble of the plurality of classification models.

10. The method of claim 1 wherein the plurality of layers of nodes include a reduction layer, at least one convolutional layer, a concatenation layer, at least one deconvolutional layer, and a labeling layer.

11. The method of claim 1 further comprising using the cloud generation module executing on the one or more processors to train the classification model.

12. The method of claim 1 further comprising using the cloud generation module executing on the one or more processors for evaluating one or more classification models.

13. A system for shadow and cloud masking for remotely sensed images of an agricultural field, the system comprising:
a computing system having at least one processor for executing a cloud mask generation module, the cloud mask generation module configured to:
receive an observed image, the observed image comprising a plurality of pixels and each of the pixels associated with corresponding band information;
determine a classification for each of the plurality of pixels in the observed image using the band information by applying a classification model, the classification model comprising a convolutional neural network comprising a plurality of layers of nodes;
wherein the cloud mask generation module applies a plurality of transformations to transform data between layers in the convolutional neural network to generate a cloud map.

14. The system of claim 13 wherein the classification is selected from a set comprising a cloud classification, a shadow classification, and a field classification.

15. The system of claim 13 wherein the classification of each of the pixels is performed using five or fewer bands of the observed image.

16. The system of claim 13 wherein the classification model is an ensemble of a plurality of classification models and wherein the classification is an aggregate classification based on the ensemble of the plurality of classification models.

17. The system of claim 13 wherein the plurality of layers of nodes include a reduction layer, at least one convolutional layer, a concatenation layer, at least one deconvolutional layer, and a labeling layer.

18. The system of claim 13 wherein the cloud generation module is further configured to train the classification model.

19. The system of claim 13 wherein the cloud generation module is further configured to evaluate one or more classification models.

20. The system of claim 13 wherein the computer system is further configured to apply the cloud mask to the observed image and using a resulting image to generate a yield prediction for the agricultural field.
